(19) United States
(12) Patent Application Publication
(10) Pub. No.: US 2007/0294078 A1
(43) Pub. Date: Dec. 20, 2007

(54) Language Conversation System And Service Method Moving In Combination With Messenger

(76) Inventors: Kang-Ki Kim, Gyeongju-Si (KR); Han-Jin Shin, Daegu (KR)

Correspondence Address: GWIPS;PETER T. KWON, P.O. BOX 231630, CENTERVILLE, VA, 20120, US

(21) Appl. No.: 11/791,228

(22) PCT Filed: Nov. 22, 2005
(86) PCT No.: PCT/KR05/03956

§ 371 Date: May 21, 2007

(30) Foreign Application Priority Data
Nov. 22, 2004 (KR) 10-2004-0095817

(51) Int. Cl. G06F 17/28

(52) U.S. Cl. 704/2

(57) ABSTRACT

Disclosed is a language conversion system and a service method thereof, capable of allowing a user to easily obtain foreign language translation data while using a messenger by operating a skin for a messenger application helper in combination with the messenger based on window message information of the messenger without accessing a messenger server The language conversion system provides a language conversion service to a plurality of terminal equipments connected to an Internet network and includes a server module and a DB server. The server module provides a messenger application controller, which forms the skin for the messenger application helper at one side of the messenger activated in the terminal equipment, to the terminal equipment, receives information value, which is selected and changed by the user, from the messenger and the skin for the messenger application helper and requests data corresponding to the information value to the DB server The server module transfers the data output ted from the DB server to the skin for the messenger application helper. The DB server extracts foreign language data approximate to the data inputted into the server module by the user from a corpus database and transfers the foreign language data to the skin for the messenger application helper The user is able to make real-Lime communication with foreigners through the messenger by utilizing the language conversion service without separately displaying an electronic dictionary or a translation program on a window screen.

### TECHNICAL FIELD

The present invention relates to a language conversion system and a service method thereof. More particularly, the present invention relates to a language conversion system and a service method thereof provided in combination with a messenger, capable of allowing a user to easily make communication with a foreigner through the messenger by utilizing a skin for a messenger application helper, which cooperates with the messenger.

### BACKGROUND ART

In these days of globalization, the role of information and communication technologies based on the Internet has become more important and serious. In particular, as communication using an Internet messenger has been universalized, there is great necessity of making communication with other users by using foreign languages. Nevertheless, most users may feel inconvenienced or uncomfortable when they communicate with foreigners using foreign languages. Although this is basically derived from the poor ability of the users against foreign languages, such a situation may be improved if there is an application program for supporting the foreign languages. Recently, the environment of computing has been rapidly developed with the progress of computer devices. For instance, the user can make communication with foreigners through an Internet messenger while separately displaying an electronic dictionary or a tag-type language translation program on a window screen.

### DISCLOSURE

### TECHNICAL PROBLEM

However, the users may feel inconvenienced when using the electronic dictionary or the tag-type language translation program. In addition, since most language translation programs do not contain expressions suitable for Internet chatting performed thorough the messenger, they cannot precisely translate words and sentences used during the Internet chatting.

Thus, it is necessary to develop an application program for language conversion. However, as a matter of fact, there are many problems to be solved when developing such an application program. First of all, as the messenger has been universalized, the messenger service is provided to the users free of charge, so the heavy economic burden is imposed on the messenger service provider in order to manage the application program. In addition, there is a difficulty in establishing a foreign language conversion program dedicated for the messenger.

Therefore, the present invention has been made in view of the above-mentioned problems, and it is an object of the present invention to provide a language conversion system and a service method thereof, capable of allowing a user to easily make real-time communication with a foreigner through a messenger without separately displaying an electronic dictionary or a language translation program on a window screen by translating the native language into foreign languages in combination with the messenger based on messenger information without accessing a messenger server activated in a user's terminal when the user makes communication with foreigners through the messenger.

### TECHNICAL SOLUTION

In order to accomplish the above object, according to one aspect of the present invention, there is provided a language conversion system for providing a language conversion service to a plurality of terminal equipments connected to an Internet network, the language conversion system comprising: a server module providing a messenger application controller, which forms a skin for a messenger application helper at one side of a messenger activated in the terminal equipment, to the terminal equipment, receiving information value, which is selected and changed by a user, from the messenger and the skin for the messenger application helper, requesting a DB server to output data corresponding to the information value and transferring the output data of the DB module to the skin for the messenger application helper; and a DB server extracting foreign language data approximate to the data inputted through the server module from a corpus database and transferring the foreign language data to the server module. According to the preferred embodiment of the present invention, at least one skin for the messenger application helper is displayed in the terminal equipment. Each skin for the messenger application helper is distinguished according to an instance handle thereof and is individually executed. The executed skins share a code segment and have their own data segment.

That is, although the skins for the messenger application helper are shown as if they are processed with different codes and data, only the data are individually processed and the codes are shared.

The messenger application controller includes a window message information unit, which obtains window message information of the messenger activated in the terminal equipment and transmits the window message information to the server module, a skin storage unit for storing the skin for the messenger application helper to be formed at one side of the messenger, and a messenger analysis unit, which analyzes the window message information of the messenger so as to check whether the window message information has been changed and transmits an analysis result to the window message information unit so as to update the window message information unit. The skin for the messenger application helper is designed in such a manner that the window message information unit may include an application environment, such as execution of a specific messenger, selection of a messenger usage group, establishment of foreign languages relative to a native language, update of the skin for the messenger application helper, execution of a program, and end of a program.

In addition, the messenger application controller analyzes window system environment for the messenger, application information and user information and stores the analysis data in a messenger analysis part. The messenger application controller obtains window message information relating to the structure and operating information of the messenger selected by the user and transfers the window message information, which allows the skin to operate in combination with the messenger, to the terminal equipment.

The server module of service provider equipment includes a registration information receiving module for receiving environment establishment information of the skin for the messenger application helper, which cooperates with the messenger, from the window message information unit, an application module for transferring a window message information order of the messenger corresponding to window message information of a window activated in the terminal equipment, a login module for authenticating the user when the user requests the language conversion service using the skin of the messenger application helper, a database-link module, which cooperates with the DB server upon receiving the data through the skin for the messenger application helper so as to perform a search for foreign language data, and an input data analysis module, which analyzes the data inputted by the user and the foreign language data by comparing the data inputted by the user with the foreign language data so as to analyze accuracy of the foreign language data relative to the data inputted by the user.

The DB server of the service provider equipment includes a corpus database for storing corpus data containing a plurality of foreign languages, a data search unit, which searches corpus data of the corpus database so as to detect whether the data inputted from the terminal equipment is registered in the corpus database and to extract foreign language data having a meaning approximate to a meaning of the data inputted from the terminal equipment, and an output control unit for transferring the foreign language data extracted from the data search unit to the terminal equipment through the server module.

Herein, the data search unit searches a plurality of text data on a basis of a matching degree between the text data and data inputted from the terminal equipment and extracts foreign language data matching with the text data.

In addition, the output control unit displays foreign language data, which correspond to text data extracted from the corpus database and dragged by a mouse, in a window message tool tip connected to the mouse.

According to another aspect of the present invention, there is provided a method for providing a language conversion service to a plurality of terminal equipments connected to an Internet network, the method comprising the steps of: providing a messenger application controller to the terminal equipment, wherein the messenger application controller forms a skin for a messenger application helper, which cooperates with a messenger, at one side of the messenger activated in the terminal equipment; searching and extracting a plurality of foreign language data approximate to data inputted by a user through the skin of the messenger application helper; and transferring the extracted foreign language data to the terminal equipment.

According the preferred embodiment of the present invention, the method further comprises a step of assigning a membership to a user upon request of the user by allocating an ID and a password to the user.

The searching and extracting step includes the substeps of receiving window message information of a window activated in the terminal equipment from the messenger application controller and performing user authentication when the user requests the foreign language conversion service.

In addition, the method further comprises a step of comparing the foreign language data extracted from the DB server with the data inputted by the user, thereby analyzing accuracy of the foreign language data relative to the data inputted by the user.

### ADVANTAGEOUS EFFECTS

As described above, a language conversion system and a service method thereof for a messenger according to the present invention have advantages as follows:

Users can easily use a language conversion service without separately displaying an electronic dictionary or a language translation program on a window screen by utilizing a skin for a messenger application helper operating in combination with the messenger when they use the foreign languages or make communication with foreigners.

In addition, translated foreign language data are provided to the user in real time as requested by the user even if the user is using the messenger, so that the user can use the foreign languages or make communication with foreigners while using the messenger.

Furthermore, a corpus database is continuously updated based on the analysis result of the translated foreign language data, so that the user can obtain more accurate translation data.

### DESCRIPTION OF DRAWINGS

The foregoing and other objects, features and advantages of the present invention will become more apparent from the following detailed description when taken in conjunction with the accompanying drawings in which:

FIG. 1 is a block view illustrating the structure of a foreign language conversion system for a messenger according to one embodiment of the present invention;

FIG. 2 is a block view illustrating the structure of a messenger application controller of a foreign language conversion system for a messenger according to one embodiment of the present invention;

FIG. 3 is a view illustrating start icons of a skin for a messenger application helper installed in a start program tray of a user terminal in a foreign language conversion system for a messenger according to one embodiment of the present invention;

FIG. 4 is a view illustrating the structure of service provider equipment providing a language conversion service for a messenger according to one embodiment of the present invention;

FIG. 5 is a view illustrating a basic format of a messenger and a skin for a messenger application helper installed at a lower portion of the messenger in a foreign language conversion system for a messenger according to one embodiment of the present invention;

FIG. 6 is a view illustrating the extension structure of a messenger and a skin for a messenger application helper installed at a lower portion of the messenger in a foreign language conversion system for a messenger according to one embodiment of the present invention;

FIG. 7 is a flowchart illustrating the procedure of a language conversion service for a messenger according to one embodiment of the present invention;

FIG. 8 is a view illustrating a messenger window, which is displayed when a user inputs an ID and a password, according to a first embodiment of the present invention;

FIG. 9 is a view illustrating a messenger window for performing the search process according to a first embodiment of the present invention;

FIG. 10 is a view illustrating a messenger window displaying an input process for a search result according to a first embodiment of the present invention;

FIG. 11 is a view illustrating a second embodiment of the present invention;

FIG. 12 is a view illustrating a third embodiment of the present invention; and

FIG. 13 is a view illustrating a fourth embodiment of the present invention.

### BEST MODE

Reference will now be made in detail to the preferred embodiments of the present invention.

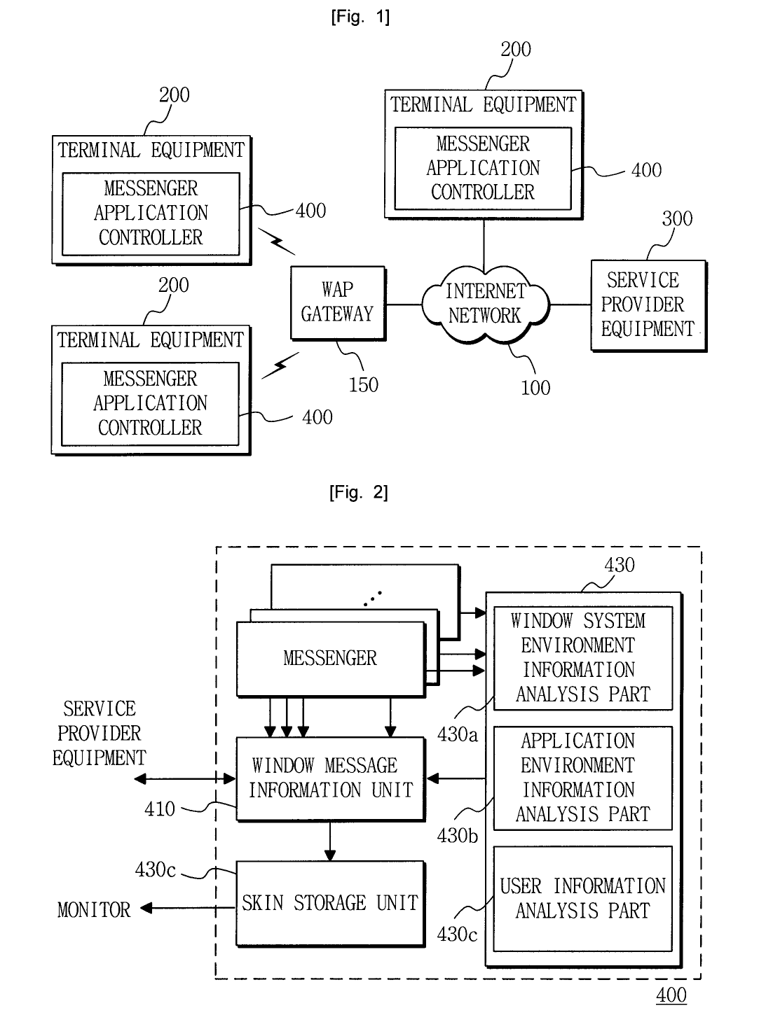

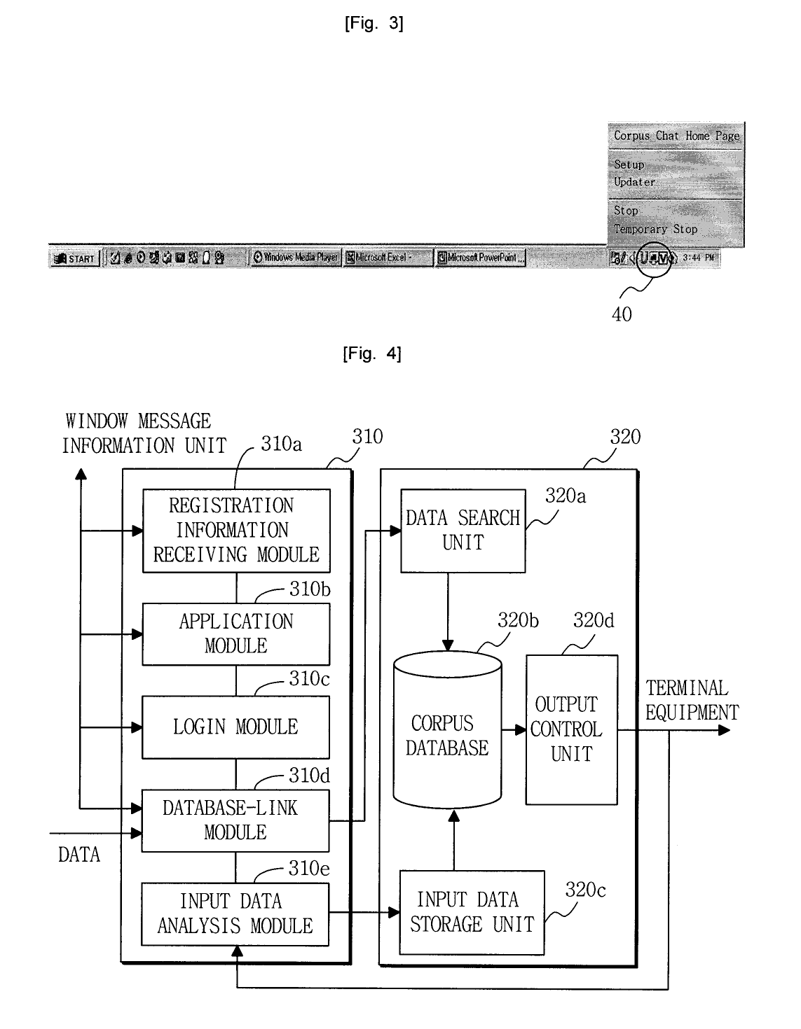

FIG. 1 is a block view illustrating the structure of a foreign language conversion system for a messenger according to one embodiment of the present invention, FIG. 2 is a block view illustrating the structure of a messenger application controller installed in terminal equipment of the foreign language conversion system according to one embodiment of the present invention, and FIG. 3 is a view illustrating start icons of a skin for a messenger application helper installed in a start program tray of a user terminal in a foreign language conversion system for a messenger according to one embodiment of the present invention.

As shown in FIG. 1, the foreign language conversion system according to one embodiment of the present invention includes an Internet network 100, a plurality of client terminal equipments 200 connected to the Internet network 100, and service provider equipment 300 connected to the Internet network 100 so as to provide translated foreign language data, which are approximate to data inputted through a messenger or a skin for a messenger application helper activated in the terminal equipment 200, to the terminal equipment 200 through the Internet network 100. Preferably, the terminal equipment 200 includes a PC, a mobile communication terminal or a PDA. Basically, the terminal equipment 200 drives a messenger program in a window program. In particular, the terminal equipment 200 displays the skin for the messenger application helper required for the language conversion service according to the present invention. Reference numeral 150 represents a WAP gateway.

A window application controller 400, which is a program for controlling the skin for the messenger application helper, is accommodated in the terminal equipment 200. The window application controller 400 can be downloaded from the service provider equipment 300 through the Internet network 100 or can be recorded in a recording medium (an FD, a CD, or a memory stick) in such a manner that the terminal equipment 200 can execute the window application controller 400 using the recording medium. The window application controller 400 analyzes data of an address, an execute application information and a link information key value of a messenger program activated in the terminal equipment 200, that is, the window application controller 400 analyzes window message data related to the messenger and stores the analyzed result in a window message information unit 410 in order to provide the analyzed result to a server module 310 of the service provider equipment 300.

As shown in FIG. 2, the window application controller 400 mainly includes the window message information unit 410, a skin storage unit 420 and a messenger analysis unit 430. Here, the messenger analysis unit 430 includes a window system environment information analysis part 430a, an application environment information analysis part 430b, and a user information analysis part 430c.

The window message information unit 410 has address information, skin information, movement information and operating information of the messenger activated in the terminal equipment 200. At this time, the skin information of the messenger 410 may be skin data or a simple URI (universal resource identifier) indicating the skin data. The window message information unit 410 reads structure information of the activated messenger and outputs a control signal to the skin storage unit 420 so as to display the skin for the messenger application helper on a screen of the terminal equipment 20. At the same time, the window message information unit 410 transfers registration information of the activated messenger to a registration information receiving module 310a of the service provider equipment 300.

The messenger analysis unit 430 analyzes information relating to the activated messenger and checks whether the content of the messenger information has been changed. If the messenger information has been changed, the messenger analysis unit 430 transfers the changed information to the window message information unit 410 so as to update the messenger information.

If a specific messenger is activated in the client terminal equipment 200, the window application controller 400 enables the messenger analysis unit 430 to analyze window system environment information, application information and user information and to transfer the analysis result to the window message information unit 410. Thus, the window message information unit 410 controls the skin storage unit 420 in such a manner that the skin for the messenger application helper can be displayed according to structure information of the activated messenger in the direction of a transverse axis (X-axis) or a longitudinal axis (Y-axis) thereof. In addition, the messenger and the skin for the messenger application helper are displayed in correspondence with the structure information of the activated messenger. At this time, the skin for the messenger application helper, which cooperates with the messenger, is displayed in one or plural terminal equipments operating in combination with the messenger driven by the user. The skin for the messenger application helper is displayed at one side of the messenger, which is discretely driven according to the instance handle thereof. At this time, the skin for the messenger application helper displayed in the messenger is individually executed. However, each skin for the messenger application helper does riot have both the individual code segment and the individual data segment, but only have the individual data segment while sharing the code segment. That is, although the skins for the messenger application helper are shown as if they are processed with different codes and data, only the data are individually processed and the codes are shared.

Meanwhile, as the skin for messenger application helper is activated, the user sets the format and operating information of the skin, that is, the user sets the application information for the skin, such as execution of a specific messenger, selection of the messenger usage group, establishment of foreign languages relative to the native language, update of the skin for the messenger application helper, execution of the program, and end of the program, and stores the above information. At this time, in order to establish the environment, as shown in FIG. 3, start icons 40 are positioned in a start program tray of the terminal equipment 200, so that the user can easily establish various application environments of the skin for the messenger application helper. Thus, the structure and operating information of the window application controller may provide the environment allowing the user to use the language conversion service using the skin of the messenger application helper.

The service provider equipment 300 is connected to the Internet network 100 so as to receive information of the messenger activated in the terminal equipment 200 and user information through a window message of the window application controller of the terminal equipment 200. In addition, data obtained by dragging the content of the messenger using a mouse or through a data search window of the skin for the messenger application helper are transferred to a DB server through a server module, so that the DB server sends translation data approximate to the data to the terminal equipment 200 through the Internet network 100.

As shown in FIG. 4, the provider equipment 300 mainly includes the server module 310 and the DB server 320.

The server module 310 includes a registration information receiving module 310a, an application module 310b, a login module 310c, a database-link module 310d and an input data analysis module 310e. In addition, the DB server 320 includes a data search unit 320a, a corpus database 320b, an input data storage unit 320c and an output control unit 320d.

Herein, the server module 310 may not access a server (not shown) of a messenger service provider, but directly control the database for the foreign language conversion based on the window message data of the messenger, which are obtained by the window application controller 400 accommodated in the terminal equipment 200.

The registration information receiving module 310a of the server module 310 receives the window message information of the skin for the messenger application helper including structure and environment information of the messenger currently activated in the terminal equipment 200 from the window application controller accommodated in the terminal equipment 200, preferably, from the window message information unit 410. The application module 310b transfers an order corresponding to window message information of a window activated in the terminal equipment 200. In detail, the activated messenger or the skin for the messenger application helper is distinguished based on the instance handle thereof, so that the result value of the information requested by the window message is displayed in the activated window.

The login module 310c cooperates with a membership database (riot shown) so as to authenticate the user who wants to use the language conversion service for the messenger.

The database-link module 310d displays foreign language data translated from text data, which are provided in an area dragged by a mouse, in a window message tool tip connected to the mouse and transmits the data inputted into the skin for the messenger application helper to the DB server 320. In addition, the database-link module 310d receives the resultant value of the input data and sends the resultant value of the input data to the message window of the messenger or to the output screen of the skin for the messenger application helper. Thus, the search and extraction of the translated foreign language data approximate to the input data can be performed in the DB server 320.

Meanwhile, the DB server 320 includes the data search unit 320a, the corpus database 320b, the input data storage unit 320c and the output control unit 320d, in which the data search unit 320a searches corpus data registered in the corpus database 320b, extracts translated foreign language data approximate to the text data inputted by the user from the corpus data, arid sends the translated foreign language data to the output control unit 320d. Herein, the term “translated foreign language data” refers to data made up of foreign languages selected by the user.

Therefore, a plurality of foreign languages including Korean, English, German, French, Japanese, Chinese, and Spanish languages may be registered in the corpus database 320b. The foreign languages can be prepared in the form of text data or audio data for image chatting.

For instance, if the user inputs the text data with the Korean language and selects the English language as the foreign language for the Korean language, the data search unit 320a searches the Korean text data matching with the inputted text data from the corpus database 320b, selects a plurality of Korean text data in the sequence of the matching degree relative to the text data, and extracts English text data matching with the selected Korean text data.

As shown in FIG. 4, the output control unit 320d outputs the translated foreign language data extracted from the corpus database 320b in the form of the foreign language, which is set in the window message information unit 410. In addition, the data dragged by the mouse are outputted while being translated into the language of the relative country based on the language of the data recognized in the data search unit 320a through the server module 310. Meanwhile, the translated foreign language data outputted from the output control unit 320d are inputted into the input data analysis module 310e of the server module 310 and are subject to the log-analysis so as to detect the matching degree between the data inputted by the user and the translated foreign language data. Thus, it is possible to detect omissions or accuracy of the translated foreign language with respect to the data inputted by the user. If it is determined that the foreign language data corresponding to the data inputted by the user are not provided in the corpus database 320b or the accuracy of the translated foreign language is very poor, the corpus data registered in the corpus database 320b are corrected/updated or new corpus data are added to the corpus database 320b in such a manner that the foreign language data approximate to the data inputted by the user can be outputted.

Hereinafter, description will be made in relation to the skin for the messenger application helper in cooperation with the messenger in the foreign language conversion system according to one embodiment of the present invention.

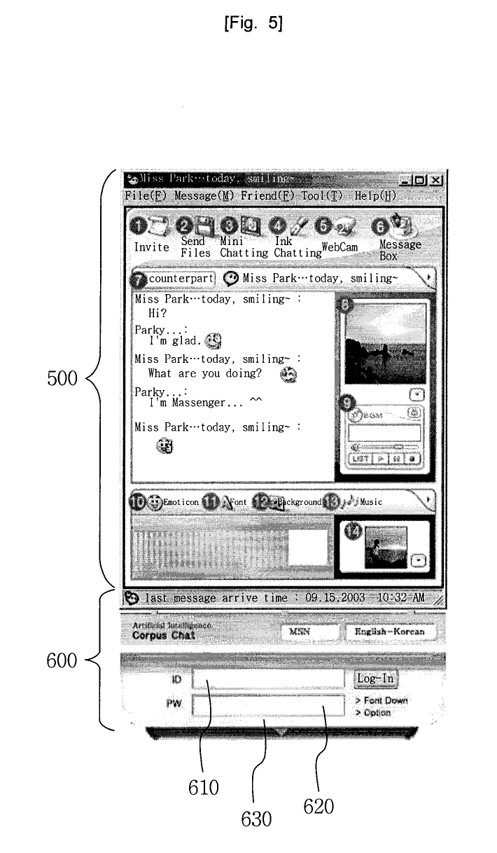

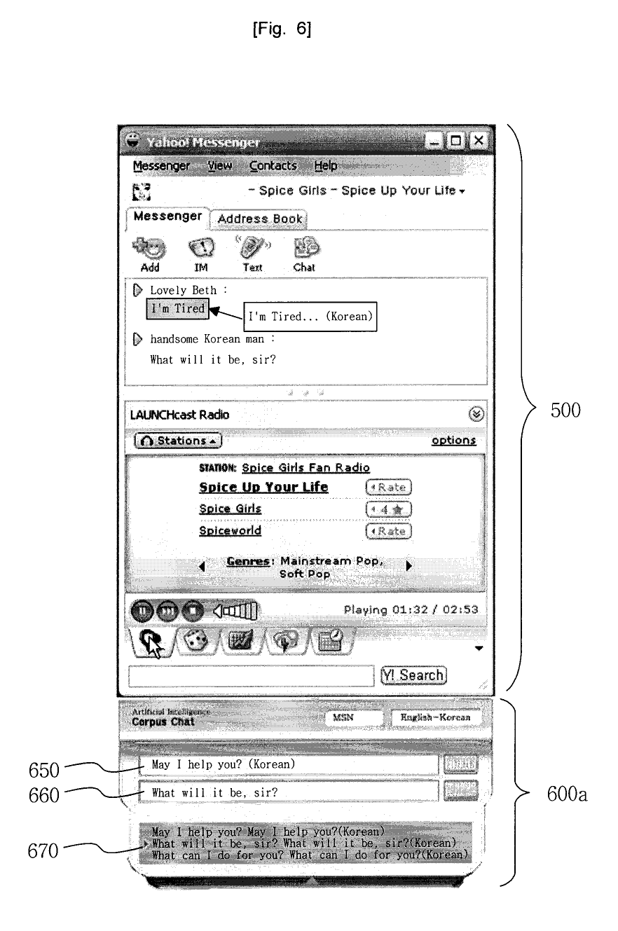

FIG. 5 is a view illustrating the skin for the messenger application helper installed at a lower portion of the messenger, and FIG. 6 is a view illustrating the extension structure of the skin for the messenger application helper. As shown in FIG. 5, the upper left portion of the skin 600 for the messenger application helper is positioned at the lower left portion of the messenger 500 and the upper right portion of the skin 600 for the messenger application helper is positioned corresponding to the lower right portion of the messenger 500. At this time, the user can reduce or enlarge the size of the messenger 500, that is, the messenger 500 has a variable size. Thus, the final size of the skin 600 for the messenger application helper may vary depending on the final size of the messenger 500, which is adjustable by the user. For reference, the position of the skin 600 for the messenger application helper is not limited to the lower end of the messenger 500. That is, the skin 600 for the messenger application helper can be positioned at the left portion, the right portion, or the upper portion of the messenger 500.

Such a basic format of the skin 600 for the messenger application helper includes an ID input window 610 and a password input window 620 for membership authentication. In addition, an extension button 630 is provided at the lower end portion of the skin 600 for the messenger application helper. If the user clicks the extension button 630, a skin 600a for the messenger application helper representing a search result display window 670 as shown in FIG. 6 is displayed.

Herein, as shown in FIG. 5, if the user inputs the ID and password so as to use the language conversion service, the login module 310c of the service provider equipment 300 checks the membership of the user in combination with the membership database (not shown). If it is determined that the user has the membership for the service, as shown in FIG. 6, the skin 600a for the messenger application helper including a data search window 650, a search result input window 660 and the search result display window 670 is displayed.

Then, if the user inputs data into the data search window 650, the database-link module 310d transmits the data inputted into the data search window 650 to the data search unit 320a of the DB server 320. Thus, the data search unit 320a extracts n pieces of foreign language data approximate to the data from the corpus database 320b and sends the foreign language data to the output control unit 320d. Upon receiving the foreign language data, the output control unit 320d displays the foreign language data in the order of accuracy thereof in the search result display window 670. At the same time, the output control unit 320d displays the uppermost data in the search result display window 670 in the search result input window 660.

In this state, if the user selects one of n pieces of foreign language data displayed in the search result display window 670, the selected foreign language data can be recorded in the search result input window 660 through the copy and paste functions.

Meanwhile, the user can view the foreign language data approximate to the text data inputted by the user through dragging the text data displayed in the messenger using the mouse. That is, if the user drags the sentence displayed in the messenger using the mouse without inputting the text data in the data search window 650 of the skin 600a of the messenger application helper, the window message information unit 410 of the window application controller 400 recognizes the text data existing in the area dragged by the mouse and sends the text data to the service provider equipment 300. Thus, the text data is applied to the database-link module 310d of the server module, so that the corpus database 320b of the DB server 320 searches and extracts the foreign language data approximate to the text data, and then displays the foreign language data in the tool tip connected to the mouse through the output control unit 320d. At this time, the data dragged by the mouse are outputted while being translated into the language of the relative country based on the language of the data recognized in the data search unit 320a. For instance, when the user makes conversation with other user using English, if the user drags the sentence “What can I do for you?” displayed in the messenger window, the Korean language corresponding to the sentence “What can I do for you?” is displayed in the tool tip connected to the mouse.

Hereinafter, a method for the language conversion service in combination with the messenger according to one embodiment of the present invention will be described with reference to accompanying drawings.

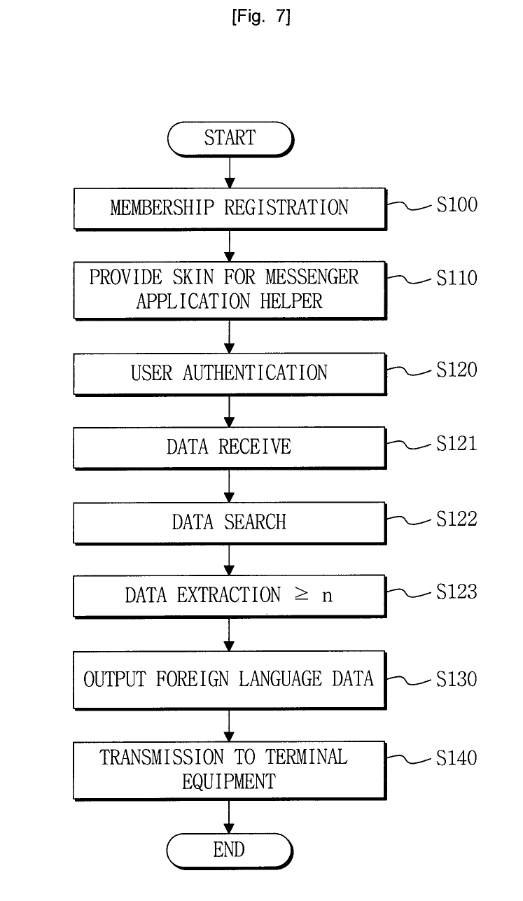

FIG. 7 is a flowchart illustrating the procedure of the language conversion service in combination with the messenger according to one embodiment of the present invention.

As shown in FIG. 7, the method for the language conversion service in combination with the messenger according to one embodiment of the present invention includes the steps of providing a skin for a messenger application helper (S110), authenticating the membership in response to the request of the language conversion service from the user (S120), extracting foreign language data approximate to data inputted by the user (S130), and providing the extracted foreign language data to the terminal equipment 200 (S140).

Before the skin for the messenger application helper has been provided to the user, a membership registration step (S100) is performed, in which user information inputted by the user who wants to join the language conversion service is registered in the membership database (not shown), and an ID and a password are allocated to the user so as to allow the user to use the language conversion service. In addition, a step of selecting a payment type and a payment tool for the use of the language conversion service can be added.

In the step of providing the skin for the messenger application helper (S110), the window application controller 400 is provided as requested by the user. Preferably, the terminal equipment 200, which accesses the server module 310 of the service provider equipment 300 through the Internet network 100, downloads the program of the window application controller 400 for controlling and driving the skin for the messenger application helper in step (S110).

In this state, if the user activates one of the messengers registered in the terminal equipment 200 of the user, the window application controller 400 obtains window message information including registration information of the activated messenger and transmits the window message information to the server module 310 of the service provider equipment 300. At the same time, the window application controller 400 controls the skin storage unit 420, thereby displaying the skin 600 for the messenger application helper as shown in FIG. 5 at one side of the messenger, preferably, at a lower end portion of the currently activated messenger. If the user adjusts the size of the messenger, the window application controller 400 detects it and adjusts the size of the skin 600 for the messenger application helper corresponding to the size of the messenger while taking the structure and operating information of the messenger into consideration.

Membership authentication step (S120) is performed in order to authenticate the user by using the ID and the password of the user when the user wants to use the language conversion service during the conversation with the foreigner while the skin 600 for the messenger application helper is being displayed at one side of the messenger. According to membership authentication step (S120), the user must input the ID and the password of the user in the ID input window 610 and the password input window 620 of the skin 600 for the messenger application helper displayed at the lower end portion of the messenger and the ID and the password of the user are transferred to the login module 310c of he server module 310 through the Internet network 100. Thus, the login module 310c of he server module 310 authenticates the user in combination with the membership database (not shown). At this time, if the user has already joined the language conversion service, the skin 600a for the messenger application helper representing the data search window 650, the search result input window 660 and the search result display window 670 is displayed at the lower end portion of the messenger.

In this state, the user input -the data. That is, the user inputs the data into the data search window 650 displayed in the skin 600a for the messenger application helper as shown in FIG. 6, or drags the dialogue sentence displayed in the screen of the messenger 500 using the mouse. In the case of the former, if the user inputs the data into the data search window 650, for example, if the user inputs the Korean text data corresponding to “May I help you?”? into the data search window 650, the Korean text data are transferred to the data search unit 320a through the database-link module 310d (S121).

Then, the data search unit 320a searches the Korean text data, which are approximate to the text data inputted by the user, from the corpus database 320b (S122) and extracts a plurality of Korean text data in the sequence of the matching degree thereof (S123). After that, the data search unit 320a outputs the foreign language data matching with the extracted Korean text data (S130). In other words, the data search unit 320a searches the Korean text data from the corpus database 320b according to the matching degree between the Korean text data and the text data inputted by the user, and finally outputs the foreign language data (English, French, Chinese, German, or Spanish language) matching with the Korean text data. At this time, the database-link module 310d transmits the text data inputted by the user to the input data analysis module 310e so as to allow the input data analysis module 310e to analyze the accuracy of translated foreign language data.

When the translated foreign language data have been outputted through the above procedure, the translated foreign language data are transferred to the output control unit 320d and then transmitted to the terminal equipment 200 through the Internet network 100 (S140). Accordingly, as shown in FIG. 6, the translated foreign language data are displayed in the search result display window 670 of the skin 600a for the messenger application helper displayed at the lower end port-ion of the messenger 500. At this time, the translated foreign language data may be displayed according to the matching degree thereof relative to the Korean text data. In this state, if the user selects one from the translated foreign language data of “May I help you?” “What will it be, sir?”? and “What can I do for you?”? displayed in the search result display window 670, the selected foreign language data are displayed in the search result input window 660. For reference, FIG. 6 shows the search result input window 660 when the user selects the translated foreign language data of “What will it be, sir?”

Hereinafter, description will be made with regard to the case, in which the text data displayed in the messenger are dragged by means of the mouse without inputting the data into the data search window 650.

When the user cannot understand the foreign language text data (for example, English text data) displayed in the messenger during communication with the foreigner through the messenger, as described above, the user can understand the meaning of the foreign language text data if the user inputs the foreign language text data into the data search window 650 and checks the Korean text data displayed in the search result display window 670. In addition, if the user drags the foreign language text data displayed in the messenger using the mouse, the Korean text data corresponding to the foreign language text data are displayed in the tool tip connected to the mouse.

For instance, when the foreigner inputs the sentence “I'm tired”? in the dialogue window, if the user drags the sentence “I'm tired”? using the mouse, the window message information unit 410 can recognize the drag area appointed by the mouse and the text data provided in the drag area are transmitted to the data search unit 320a. Upon receiving the text data, the data search unit 320a checks whether a sentence matching with “I'm tired”? is registered in the corpus database 320b. If the sentence matching with “I'm tired”? has already been registered in the corpus database 320b, the Korean text data corresponding to the English sentence “I'm tired”? are outputted. The outputted Korean text data are displayed in the tool tip connected to the mouse through the output control unit 320d.

### MODE FOE INVENTION

### Embodiment 1

FIG. 8 is a view illustrating a messenger window, which is displayed when a user inputs an ID and a password, according to a first embodiment of the present invention.

Referring to FIG. 8, according to the first embodiment of the present invention, an ID input window 810 is displayed on the skin 800 for the messenger application helper. If the user inputs the ID and the password of the user into the ID input window 810, the skin 800 for the messenger application helper operates in combination with the messenger 700.

To this end, the ID input window 810 is equipped with an ID/password storage function for allowing the user to previously input and store the ID/password of the user, an automatic login function for allowing the user to automatically login the messenger as the ID input window 810 is displayed, and a link function for allowing -the user to access other Internet sites. The above functions may cooperate with the membership database so as to provide the user with the high quality language conversion service.

Herein, the messenger 700 includes a dialogue input window 710 for allowing the user to input sentences or words. The skin 800 for the messenger application helper includes a data search window 820 having an integrated function of the data search window 650 and the search result input window 660, and a search result display window 830.

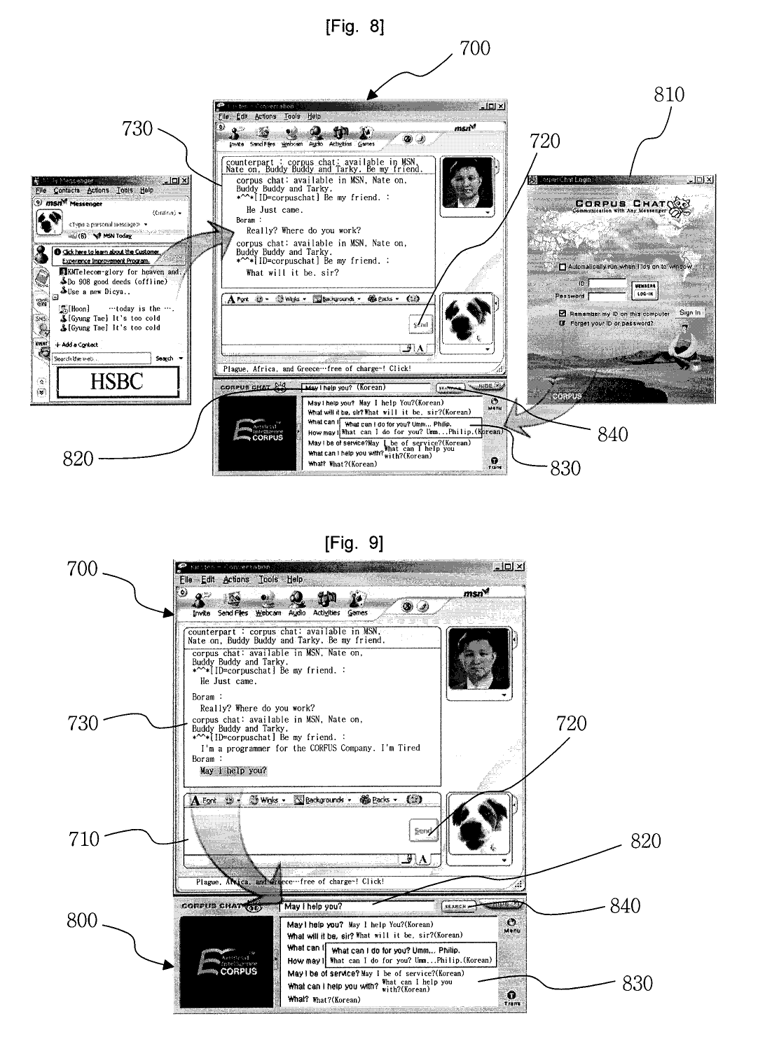

FIG. 9 is a view illustrating a messenger window for performing the search process according to the first embodiment of the present invention.

Referring to FIG. 9, when it is necessary to input search words into the data search window 820 (which is similar to the data search window shown in FIG. 6) of the skin 800 for the messenger application helper, the user may directly input the search words into the data search window 820 or may drag the sentences or words displayed in a dialogue window 730 of the messenger 700 using the mouse.

The dialogue sentence dragged by the mouse is displayed in the data search window 820. In addition, as the user clicks a search button 840, foreign language data (for example, English language data) corresponding to the dialogue sentences (for example, Korean dialogue sentence) are displayed in the search result display window 830.

That is, the window message information unit 410 of the window application controller 400 recognizes the text data (that is, the dialogue sentence dragged by the mouse) and the text data recognized by the window message information unit 410 of the window application controller 400 are inputted in the form of “copy”? by means of the service provider equipment 300. The inputted text data (the dialogue sentence) undergoes the search process as described above.

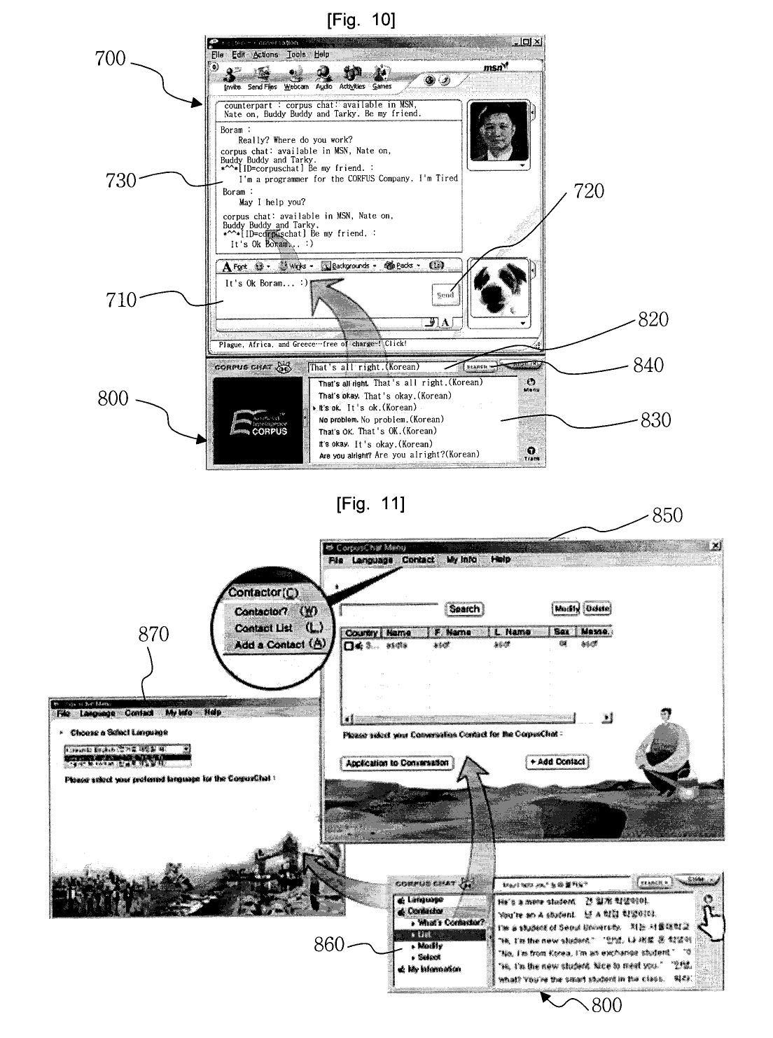

FIG. 10 is a view illustrating the messenger window displaying an input process for the search result according to the first embodiment of the present invention.

Referring to FIG. 10, in order to input the search result obtained through the above procedure into the dialogue window, the user double-clicks the text data displayed in the search result display window 830. In this case, the text data are copied and the copied text data are displayed in the dialogue input window 710 of the messenger 700 in the form of a text.

That is, the text data are block-type data (that is, hypertext data having the copy command), which are automatically copied when the user double-clicks the text data using the mouse. Then, the text displayed in the dialogue input window 710 of the messenger 700 can be displayed in the dialogue window 730 when the user clicks a send button 720. Of course, the user can correct the text before clicking the send button 720.

According to the first embodiment of the present invention described above, the user can conveniently use the language conversion service having the high quality.

### Embodiment 2

FIG. 11 is a view illustrating a second embodiment of the present invention.

Referring to FIG. 11, the language conversion system for the messenger according to the second embodiment of the present invention allows the user to previously store a plurality of counterparts in a database so that the user can conveniently input/output the contents of dialogue.

To this end, the language conversion system according to the second embodiment of the present invention includes a data input window 850 as an option so as to add the counterparts in the database.

The data input window 850 includes an option window 860 so as to allow the user to input information of the counterparts into the optical window 860. That is, the option window 860 includes various items, such as a counterpart list, a counterpart add, a counterpart select, and my information, each of which is linked with the data input window 850.

In particular, the option window 860 includes an option setting window 870 for setting a display time, a display condition, etc. In addition, the country, the name, the sex, and the messenger ID of the counterpart can be inputted into the data input window 850.

In this state, if the user selects the counterpart from the option window 860 before the user makes communication with the counterpart or during the communication, the search process is carried out in the same manner described above and the dialogue sentence suitable for the selected counterpart is displayed in the dialogue input window 710.

In detail, when text data of “Hi, Tom”? has been inputted from among corpus data and the user selects “Jone”? as a communication counterpart, if the user double-clicks the text data of “Hi, Tom” the text data of “Hi, Jone”? is automatically displayed in the dialogue input window.

In addition, when the user performs the self-introduction, if the user name is “Sujan” the text data of “Hi, Tom”? is automatically converted into “Hi, Sujan” so that the text data “Hi, Sujan”? may be displayed in the dialogue input window 710 of the messenger 700.

To this end, the corpus database 320b containing the name, the sex, etc. of the counterpart and the user must be previously established. In addition, the corpus database 320b must be linked with the database containing data of the counterparts in such a manner that the language, the name, the sex, etc. of the counterpart and the user can be automatically distinguished according to the search result.

### Embodiment 3

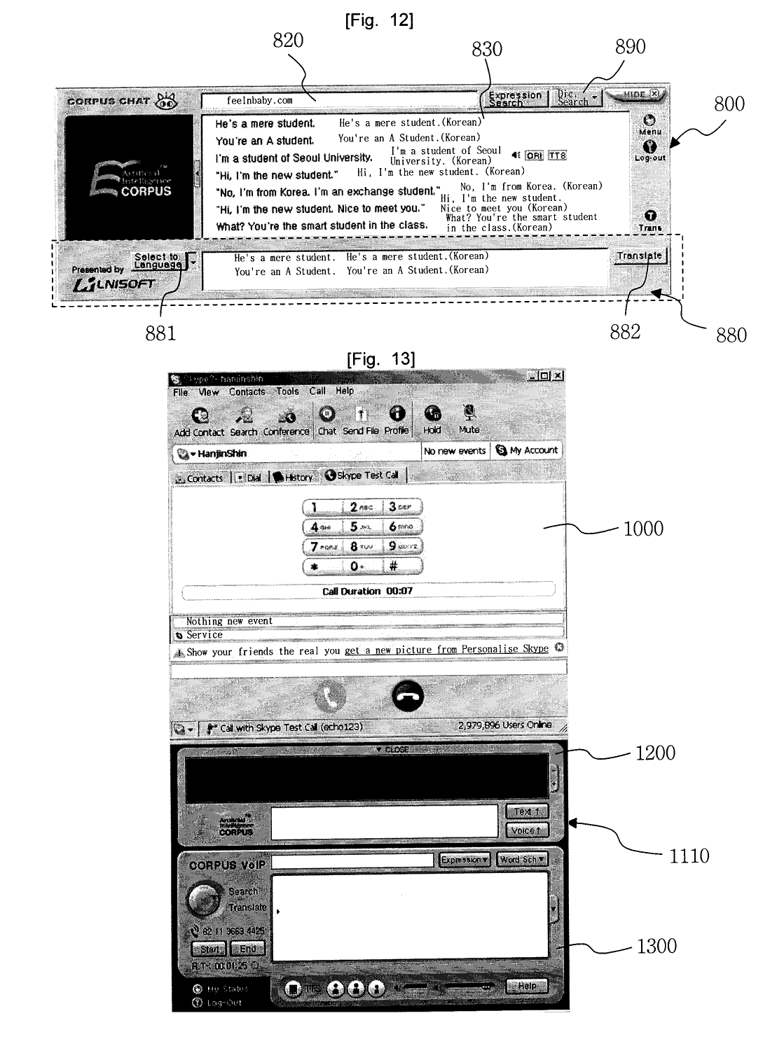

FIG. 12 is a view illustrating a third embodiment of the present invention.

Referring to FIG. 12, the skin 800 for the messenger application helper includes a translation window 880 provided with a language selection button 881 for selecting the language to be translated and a translation button 882 for executing translation work.

In the language conversion system according to the third embodiment of the present invention, the text data displayed in the dialogue window 730 and the dialogue input window 710 of the messenger 700 or the data search input window 820 of the skin 800 for the messenger application helper are designated (dragged or copied) or the text is directly inputted into the translation window 880 by the user. In this state, if the user clicks the translation button 882, the text is automatically translated and the translated text is displayed in the translation window 880.

To this end, the translation window 880 including the language selection button 881 and the translation button 882 is linked with a translator database, which is typically established, or an Internet site of a company providing the translation program. In addition, the language selection button 881 is designed such that at least two types of languages can be inter-translated from among languages of various countries, such as Korea, U.S.A., China, Japan, etc. Thus, the search for the foreign languages can be variously and precisely carried out.

Additionally, the language conversion system according to the third embodiment of the present invention provides a search function for language dictionaries of various countries.

To this end, a dictionary search button 890 is formed in the skin 800 for the messenger application helper in order to allow the user to search for the dictionary. The dictionary search button 890 is linked with a database containing data regarding language dictionaries of various countries, or an Internet site supporting the language dictionary search. In this case, the user can search the language dictionaries of various countries by simply inputting the text in the data search input window 820 of the skin 800 for the messenger application helper.

### Embodiment 4

FIG. 13 is a view illustrating a fourth embodiment of the present invention.

Referring to FIG. 13, the language conversion system according to the fourth embodiment of the present invention utilizes a VoIP (voice over Internet protocol) technology (for example, an Internet telephone) in combination with the messenger and the skin for the messenger application helper.

For reference, an Internet telephony technology called a “VoIP technology”? is a communication service technology, which converts voice data into Internet protocol data packets, thereby enabling voice communication over the computer network, as if the user makes communication through a telephone line.

Reference numeral 1000 represents a dialing window of a company providing the VoIP service. The user can make a call by clicking number keys displayed in the dialing window 1000. A service window 1100 is coupled with the dialing window 1000 in order to provide the user with the language conversion service for the messenger according to the present invention in addition to voice communication and chatting services.

Reference numerals 1200 and 1300 represent a messenger and a skin for a messenger application helper, respectively, which are substantially identical to the messenger and the skin for the messenger application helper described above, except that buttons for voice communication are provided in the messenger 1200 and the skin 1300.

The language conversion system according to the fourth embodiment of the present invention has an additional system, which transmits/receives the text message and voice data and converts the text message into voice data or vice versa so as to provide the user with the voice communication service in addition to the language conversion service.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

What is claimed is:

1. A language conversion system for providing a language conversion service to a plurality of terminal equipments connected to an Internet network, the language conversion system comprising:
a server module forming a skin for a messenger application helper at one side of a messenger activated in the terminal equipment, receiving data which are selected by a user and inputted into the messenger and the skin for the messenger application helper, and transferring foreign language data approximate to the data to the terminal equipment; and
a DB server extracting foreign language data approximate to the data of the server module from a corpus database and transferring the foreign language data to the server module,
wherein said server module includes a registration information receiving module for receiving environment establishment information of the skin for the messenger application helper which cooperates with the messenger, from the window message information unit through a window message loop of the terminal equipment, an application module for transferring a window message information order of the messenger corresponding to window message information of a window activated in the terminal equipment and registered in the registration information receiving module, a login module for authenticating the user when the user requests the language conversion service using the skin of the messenger application helper, a database-link module, which cooperates with the DB server upon receiving the data through the messenger and the skin for the messenger application helper so as to perform a search for foreign language data, and an input data analysis module, which analyzes the data inputted by the user and the foreign language data by comparing the data inputted by the user with the foreign language data so as to analyze accuracy of the foreign language data relative to the data inputted by the user and the skin for the messenger application helper is provided corresponding to messengers driven by the user, each skin for the messenger application helper is distinguished according to an instance handle thereof and is individually executed, and executed skins share a code segment and have their own data segment.

2. The language conversion system as claimed in claim 1, wherein the server module provides a messenger application controller to the terminal equipment, in which the messenger application controller obtains window message information of the messenger, adjusts the skin for the messenger application helper in cooperation with the messenger, and establishes an application environment including execution of a specific messenger, selection of a messenger usage group, establishment of foreign languages relative to a native language, update of the skin for the messenger application helper, execution of a program, and end of a program.

3. The language conversion system as claimed in claim 2, wherein the messenger application controller includes
a window message information unit, which obtains the window message information of the messenger activated in the terminal equipment and transmits the window message information to the server module,
a skin storage unit for storing the skin for the messenger application helper to be formed at one side of the messenger, and
a messenger analysis unit, which analyzes the window message information of the messenger so as to check whether the window message information has been changed and transmits an analysis result to the window message information unit so as to update the window message information unit.

4. The language conversion system as claimed in claim 3, wherein the window message information unit has address information, skin information, movement information and operating information of the messenger activated in the terminal equipment, displays the skin for the application helper at one side of the activated messenger according to structure information of the messenger, and transmits registration information of the activated messenger to the server module.

5. (canceled)

6. The language conversion system as claimed in claim 3, wherein the messenger analysis unit includes
a window system environment information analysis part for analyzing a window system environment,
an application environment information analysis part for analyzing an application environment, and
a user information analysis part for storing information of a user employing the messenger.

7. (canceled)

8. The language conversion system as claimed in claim 1, wherein the DB server includes
a corpus database for storing corpus data containing a plurality of foreign languages, a data search unit, which searches corpus data of the corpus database so as to detect whether the data inputted from the terminal equipment is registered in the corpus database and to extract foreign language data having a meaning approximate to a meaning of the data inputted from the terminal equipment, and
an output control unit for transferring the foreign language data extracted from the data search unit to the server module.

9. The language conversion system as claimed in claim 8, wherein the data search unit searches a plurality of text data on a basis of a matching degree between the text data and data inputted from the terminal equipment and extracts foreign language data matching with the text data.

10. The language conversion system as claimed in claim 8, wherein the output control unit displays foreign language data, which correspond to text data extracted from the corpus database and dragged by a mouse, in a window message tool tip connected to the mouse.

11. A language conversion system for providing a language conversion service to a plurality of terminal equipments connected to an Internet network, the language conversion system comprising:
a messenger application controller accommodated in the terminal equipment so as to form a skin for a messenger application helper at one side of a messenger activated in the terminal equipment;
a server module providing the messenger application controller to the terminal equipment, and outputting foreign language data, which are made up of a foreign language selected by a user, corresponding to the data inputted from the terminal equipment when the data of the terminal equipment are received therein; and
a DB server for searching and extracting foreign language data, which are made up of a foreign language selected by a user and correspond to the data inputted from the terminal equipment, from a corpus database containing a plurality of foreign language data and transferring the foreign language data to the server module.

12. The language conversion system as claimed in claim 11, wherein the messenger application controller obtains window message information of the messenger activated in the terminal equipment, and provides structure and environment establishment information of the skin for the messenger application helper, which cooperates with the messenger, to the server module through a window message loop of the terminal equipment.

13. The language conversion system as claimed in claim 12, wherein the server module includes
an application module for transferring a window message information order of the messenger corresponding to window message information of a window activated in the terminal equipment,
a login module for authenticating the user when the user requests the language conversion service using the skin of the messenger application helper,
a database-link module, which cooperates with the DB server when data are received therein through the skin for the messenger application helper operating in combination with the messenger so as to perform a search for foreign language data corresponding to the input data, and
an input data analysis module, which analyzes the input data and the foreign language data by comparing the input data with the foreign language data so as to analyze accuracy of the foreign language data relative to the input data.

14. (canceled)

15. (canceled)

16. (canceled)

17. (canceled)

18. A method for providing a language conversion service to a plurality of terminal equipments connected to an Internet network, the method comprising the steps of:
providing a messenger application controller to the terminal equipment, wherein the messenger application controller forms a skin for a messenger application helper, which cooperates with a messenger, at one side of the messenger activated in the terminal equipment;
receiving data obtained by dragging contents displayed in a messenger window using a mouse, or data inputted into a data search window of the skin for the messenger application helper;
searching a plurality of foreign language data approximate to received data and extracting foreign language data in an order of a matching degree between the foreign language data and the received data; and
transferring the extracted foreign language data to the terminal equipment in such a manner that the foreign language data are displayed in a tool tip connected to the mouse or in a search result display window of the skin for the messenger application helper.

19. The method as claimed in claim 18, wherein the foreign language data displayed in the search result display window of the skin for the messenger application helper are made up of a foreign language selected by a user.

20. The method as claimed in claim 18, wherein the data obtained by dragging contents displayed in the messenger window using the mouse are inputted into the data search window of the skin for the messenger application helper, a search result is displayed in the search result display window in a form of text data when a search for the input data has been finished, and the text are inputted into a dialogue input window when the user double-clicks the text data so that it is possible to display the text data in a dialogue window.

21. The method as claimed in claim 18, wherein, when a search result is inputted into a dialog input window of the messenger, the search result is converted into text data corresponding to information and conditions of counterparts and the user, which are previously stored in a database.

22. The method as claimed in claim 18, wherein the skin for the messenger application helper is linked with a translator database established in a language conversion system, an Internet site of a company providing a translation program, and/or an Internet site of a company providing a database containing language dictionaries of various countries or a dictionary search program, thereby allowing the user to perform language translation and/or dictionary search.

23. The method as claimed in claim 18, wherein the messenger and the skin for the messenger application helper are linked with a server of a company providing a VoIP (voice over Internet protocol) so as to allow the user to make voice communication, and voice data of voice communication are displayed in the messenger and the skin for the messenger application helper in a form of text data, so that it is possible to convert the text data into foreign language data and to transmit/receive a text message or voice data.

24. The method as claimed in claim 18, further comprising a step of assigning a membership to a user upon request of the user by allocating an ID and a password to the user.

25. The method as claimed in claim 18, wherein the searching and extracting step includes the sub-steps of:
receiving window message information of the messenger activated in the terminal equipment from the messenger application controller;
forming the skin for the messenger application helper by transmitting information, which contains a size and a position of the skin adjusted according to the window message information, to the messenger application controller; and
performing user authentication when the user requests the foreign language conversion service.

26. The method as claimed in claim 18, further comprising a step of comparing the foreign language data with the data inputted by the user, thereby analyzing accuracy of the foreign language data relative to the data inputted by the user.
